(19) United States
(12) Patent Application Publication
(10) Pub. No.: US 2015/0242470 A1
(43) Pub. Date: Aug. 27, 2015

(54) SYSTEMS AND METHODS FOR RECOMMENDING SOFTWARE APPLICATIONS

(71) Applicant: AVG Netherlands B.V., Amsterdam (NL)

(72) Inventor: Yuval Ben-Itzhak, Prague 6 (CZ)

(21) Appl. No.: 14/710,224

(22) Filed: May 12, 2015

Related U.S. Application Data
(63) Continuation-in-part of application No. 13/117,858, filed on May 27, 2011, now Pat. No. 9,058,612.

(51) Int. Cl. G06F 17/30

(52) U.S. Cl. CPC G06F 17/30539; G06F 17/30867; G06F 17/30876; G06F 17/30595

(57) ABSTRACT

A potentially beneficial software product is recommended to a user based, in part, on an analysis of parameters associated with the user's usage of software applications already installed on the user's computer.

### CROSS-REFERENCE TO RELATED APPLICATION

This application is a continuation-in-part of and claims the benefit of U.S. patent application Ser. No. 13/117,858, filed on May 27, 2011, the disclosure of which is hereby incorporated herein by reference in its entirety.

### FIELD OF THE INVENTION

The invention relates generally to the field of recommending software products to users, and, more specifically, to systems and methods for generating recommendations for software products that are potentially beneficial to the user's system based on software application usage data.

### BACKGROUND

Consumer and professional computer systems typically include software products such as word-processing applications, picture and movie management software, and other business applications. Some of these software products are installed by the system manufacturer while other products may be purchased and installed by users of the computer system. In the software marketplace, new products are generally introduced on a regular basis, but many users are often unaware of the newly available products, particularly those offered by small vendors. A user may also not know about products that perform potentially beneficial functions that are not provided by the software applications currently installed on the user's computer.

One way in which a user may learn about newly available or previously existing software products is by searching for a product based on the functionality it performs. For example, a user may want to purchase photo-editing or backup software, in which case the user may enter such terms into a search engine, hoping for relevant results. The search results and/or context-based advertisements delivered to the user may provide information regarding potentially beneficial software products. Another situation in which a user becomes aware of software products is when the user purchases a product from a vendor. The vendor may recommend similar or beneficial products based on the purchase history of that user and/or other buyers, search terms used by that buyer and/or other consumers, and/or products that may complement the purchased product.

These approaches, however, face several limitations in identifying and recommending a potentially useful product to a user that the user is likely to buy. For example, when a user searches for a product, the search may be limited to the user's knowledge of the available functionality. In other words, if the user is not aware of any product that meets a desired functionality, the user may not search for that functionality, and hence, may not learn about a potentially useful product. The recommendations provided by vendors are usually based only on the information available to a particular vendor, which, from a user's perspective can be incomplete. For example, a user may routinely buy software products from different vendors, and hence, a certain vendor, unaware of the user's overall purchases, may recommend a product that the user already owns. Accordingly, vendor-supplied recommendations may not be helpful or even relevant to some users. Therefore, there is a need for improved methods and systems that enable recommendation of software products that are potentially beneficial to users of computer systems based on more relevant and accurate data than currently used.

### SUMMARY OF THE INVENTION

In various embodiments of the present invention, recommendations for useful or potentially valuable software applications are provided to a user. This is achieved, in part, by collecting comprehensive data about the user's computing system and its use, e.g., data that includes not only static data such as processor speed, size of the installed memory, operating system, etc., but also usage data corresponding to how the user interacts with the computer system. Examples of usage data include application-data parameters (e.g., the types of software applications installed on the computer, the frequency at which the user invokes various applications, types and sizes of files associated with the installed applications, etc.) and system parameters (e.g., available memory, average run time of an application, etc.).

Various system parameters and/or application-data parameters are collected and analyzed statistically and/or based on certain rules. By analyzing these parameters, a functionality lacking on the computer system but potentially beneficial to the user, such as a backup application, a database and/or indexing application, a financial-analysis application, computer tune-up software, etc. is identified. In contrast to conventional methods, the identification of the beneficial functionality is not based solely on the user's search for a product, or the history of products he or she purchased from a vendor (although these may be considered). Instead, software applications are identified based on what is currently installed on the system, how the existing applications are used, and the performance of those applications. Thus, the analysis is performed from a user's perspective, and is based on a comprehensive knowledge of the user's usage of the available software applications. Therefore, a software application that can provide a potentially beneficial functionality currently lacking on the user's computer, can be advantageously recommended to the user, offering a benefit unavailable in existing systems.

The analysis can also include comparing a target user's usage patterns with other users' usage patterns. Other users that use similar software applications in a similar manner may use applications not currently installed on the target user's computer system. For example, many users who use tax-preparation software provided by a certain vendor may also use a personal-finance software product supplied by a different vendor. The target user may use the tax-preparation software, but may not own the personal-finance software. Such potentially beneficial applications may be identified based on the analysis of usage patterns of the target and the other users, and may be recommended to the target user.

Accordingly, in one aspect, a computer-implemented method for recommending a category of software applications includes programmatically collecting parameters associated with usage of software applications installed on a computer. In particular, the parameters relate to the usage of the applications installed by the user. The method also includes mining the collected usage parameters to identify a potentially beneficial functionality not provided by applications presently installed on the computer (i.e., not entirely, effectively, or efficiently provided by any of the installed applications), and determining a category of software applications capable of performing the potentially beneficial functionality.

The collected usage parameters may include an execution parameter associated with the installed software applications, a system parameter, an application parameter, or combinations of one or more of the different types of parameters described above. The system parameters may include a processor type, size of available memory, disk-access time, network bandwidth constraints, installed hardware (internal and/or peripherals), and/or average data-reception time. The application parameters may include a type of an installed software application, a number of files of a type, a size of a file, and/or the frequency of use of an installed application.

In some embodiments, mining includes applying a rule to compare the collected usage parameters with a nominal value corresponding to that parameter. The mining may also include statistically analyzing the collected usage parameters. The collected usage parameters may be stored in a database. In some embodiments, the database is a local database, while in other embodiments, the database is a remote database. The database can also include both local and remote databases and include data from many users and computer systems. The software-application category identified during mining may be back-up software, indexing software, database software, or system-maintenance software, as well as other types of applications.

The method may additionally include recommending a software application (or applications) belonging to the determined category. The recommended software application (i.e., product) may be cataloged in a software-application inventory database.

In another aspect, a computer-implemented method of recommending a software application includes programmatically collecting parameters associated with a user's activities related to software applications installed on the computer. These parameters are collected at a computer on which the applications are installed and, in some cases, operating. The method also includes statistically analyzing the collected usage parameters based on reference parameters. The analysis is performed to identify a potentially beneficial software application not present on the computer, and to determine a likelihood of the user using the identified software application. In addition, the method includes recommending to the user the identified software application, based on the determined likelihood of the user using the identified software application.

In some embodiments, the method includes installing and/or executing the identified software application on the computer. The method may also include storing the collected usage parameters in a database located on the computer and, in some cases, in a remote database, which may be in a central location or distributed among numerous locations. In some embodiments, the method includes generating the reference parameters. The reference parameters can be programmatically collected parameters associated with the usage of software applications installed on other computers. Alternatively or in addition, the reference parameters can be programmatically collected parameters associated with usage by other users of software applications installed on the same computer.

In some embodiments, analyzing includes clustering, which includes determining a co-occurrence between two installed software applications. The co-occurrence may be based on the collected usage parameters and/or the reference parameters. The collected usage parameters may include a type of installed software applications, a number of files of a particular type, a size of a file, an association between a file type and the installed software applications, frequency of use of the installed software applications, and an average time of use of the installed software applications.

In yet another aspect, a system for recommending a category of software applications includes a profiler module for programmatically collecting parameters associated with usage of software applications installed on a computer, and a miner module for mining the collected usage parameters to identify a potentially beneficial functionality not present on the computer. The miner also determines a category of software applications capable of performing the identified functionality.

The system may include a database module for storing the collected usage parameters, and the database module may be configured to store rules applied by the miner to identify the potentially beneficial functionality, and/or nominal values corresponding to one of the usage parameters.

In some embodiments, the profiler module, the miner module, and the database module are located at one computer, while in other embodiments, the profiler module is located at a first computer, and the miner module and the database module are located at a different, second computer. The system may also include an inventory module including an inventory database for recommending a software application belonging to the determined category. The software application may be cataloged in the inventory database.

In yet another aspect, a system for recommending a software application includes a profiler module for programmatically collecting parameters associated with usage of software applications installed on a computer. The system also includes a database module for storing the collected usage parameters, and an analyzer module for statistically analyzing the collected usage parameters based on reference parameters. The analyzer identifies a potentially beneficial software application, determines a likelihood that the user will use the identified software application, and recommends to the user the identified software application, based on the likelihood of the user using the identified software application. The system may include an installer for installing the identified software application on the computer. The system may also include a reference database module for storing the reference parameters.

As discussed above, users can generally learn about new or existing software products by conducting Internet searches on their computers (e.g., using a search engine, such as GOOGLE, via a web browser application installed on their computers). For example, if a user searches the keyword “antivirus”, a search engine may return search results including web sites that contain information on anti-virus software products. However, search engines are massive data aggregators that crawl the web, and index and correlate words with all identified web sites—including educational sites, entertainment sites, business or commercial sites, and personal sites—that contain those words. That is, for any given keyword (e.g., “antivirus”) or term, a large number of web sites may be indexed and associated therewith in a search engine's database. Thus, even if web sites containing information on relevant software products may be included in the search results, there may be so many sites in the results that a user may never come upon a relevant software product site, before giving up or otherwise terminating the search.

Additionally, since conventional search engines merely provide search functionalities, and do not typically have access to detailed information regarding the content stored on users' computers, they are unable to tailor search results differently for different users. Furthermore, conventional web browser applications are also unable to monitor user entries, such as keywords, search terms, and uniform resource locators (“URLs”) entered into the browser application's address bar or other input fields. All of this information can be useful in identifying and recommending software applications to users.

Thus, according to various embodiments, a method for recommending software applications, involving user interaction with a web browser application installed on a computing device, is provided, and includes monitoring, using at least one processor of the computing device, application usage parameters pertaining to the web browser application installed on the computing device, mining, using the at least one processor, the application usage parameters for user inputs submitted to the web browser application, extracting, using the at least one processor, text data from the user inputs, identifying, using the at least one processor, at least one software application based at least in part on the extracted text data, and causing, using the at least one processor, the computing device to present information regarding the at least one identified software application.

In at least one embodiment, a system for recommending software applications, involving user interaction with a web browser application installed on a computing device, includes a profiler module configured to monitor application usage parameters pertaining to the web browser application installed on the computing device. The system also includes a miner module configured to mine the application usage parameters for user inputs submitted to the web browser application, extract text data from the user inputs, identify at least one software application based at least in part on the extracted text data, and cause the computing device to present information regarding the at least one identified software application.

In other embodiments, a computer program product including a non-transitory medium storing computer executable program logic for recommending software applications, involving user interaction with a web browser application installed on a computing device, is provided. The computer executable program logic is configured to cause at least one data processor of the computing device to monitor application usage parameters pertaining to the web browser application installed on the computing device, mine the application usage parameters for user inputs submitted to the web browser application, extract text data from the user inputs, identify at least one software application based at least in part on the extracted text data, and cause the computing device to present information regarding the at least one identified software application.

The computing device can be a desktop computer, a laptop computer, a notebook computer, a tablet computer, a smartphone, or a personal digital assistant. The web browser application can be any browser application that provides an address bar or other input fields for receiving user entries (e.g., text and alphanumeric characters). In some embodiments, the browser application can feature tabbed viewing of web pages, where multiple web sites are accessible via individual tabs of the browser application's window.

The application usage parameters can include any of the usage parameters described above. In various embodiments, the usage parameters can additionally, or alternatively, include user inputs (e.g., text data, such as search terms, keywords, URLs, etc.) entered into or submitted to the web browser application. The parameters can be monitored using a profiler module (e.g., similar to any of the profiler modules described above). The profiler module can be installed on the computing device, and can be implemented, for example, as an extension of the web browser application. In some embodiments, the profiler module can include one or more event handlers configured to monitor events (e.g., user input events) in the browser application. The monitored usage parameters can be stored in a usage parameters database (e.g., similar to the database module described above).

In at least one embodiment, the parameters, and more particularly, the user inputs included therein, can be mined or analyzed (e.g., individually or as a group) to identify one or more software applications that are relevant to what the user is looking for. A miner module (e.g., similar to the miner module described above) can be used to analyze the parameters for recognizable terms. The miner module can retrieve the usage parameters from the usage parameters database for analysis, or alternatively, can receive the usage parameters directly from the profiler module as they are monitored. In at least one embodiment, the miner module can access and utilize a reference database (e.g., a dictionary or other reference source) to identify keywords or terms in the user inputs. For example, if the user inputs the search term “Prague hotels”, the miner module can access and utilize the reference database to parse the user inputs and identify the words “Prague” and “hotels” therein.

The miner module can also interface with a software application inventory database (e.g., similar to the inventory database described above) to identify software applications relevant to the search words or terms. The inventory database can be a relational database (e.g., a lookup table) containing words or terms indexed with information regarding associated software applications. The miner module can query the inventory database with some or all of the identified terms or words to retrieve information regarding matching software applications. In some embodiments, the miner module can be configured to interface directly with the inventory database. In other embodiments, the miner module can communicate with the inventory database via a separate module, such as the inventory module described above.

The reference and inventory databases can be stored either in memory on the computing device, or remotely from the computing device. In some embodiments, the reference database and the software application inventory database can be implemented as a common database. In this case, the miner module can, for example, access the common database to assist with parsing the user inputs and identifying search terms or words, as well as retrieve information regarding software applications stored in the database that are relevant or match the identified search terms or words.

In at least one embodiment, in addition to analyzing the user inputs to identify terms or words, the miner module can also be configured to analyze other data in the application usage parameters that pertain to information regarding some or all of the software applications presently installed on the computing device (e.g., their associated file types, the number of files of each file type, the sizes of the files, the frequency of use of each installed software application, etc.). The miner module can then identify relevant software applications based on the terms or words identified in the user inputs as well as the usage data regarding the software applications presently installed on the computing device. For example, a user may input the search term “excel” to the web browser application. If a copy of MICROSOFT EXCEL is already installed on the user's computer, and the information regarding relevant software applications (e.g., retrieved from the inventory database) includes information on MICROSOFT EXCEL, then the miner module can filter MICROSOFT EXCEL from the recommendation. In this way, software application search and recommendation can be tailored differently for different users, depending on the applications already installed on their computing devices.

In at least one embodiment, the computing device can present the retrieved software application information to the user. The profiler module, the miner module, or one or more other suitable modules can be used to effect the presentation. In some embodiments, the appropriate module can format (or cause to be formatted) the retrieved information, and can direct a display unit on the user's computing device to display the information. For example, where the web browser application supports tabbed viewing of web pages, the information can be presented in a tab of the browser application (e.g., the same or a different tab in which the user entered the inputs).

In various embodiments, inventory database may also store actual installer files for its software applications. Any computing device equipped with an application installer module would thus be able to install the software applications. In this case, the presented recommendation can include a prompt for user instruction as to whether and which of the retrieved installer files should be executed. Upon selection of any of the installer files, the profiler module, the miner module, or any other appropriate module, can retrieve the selected file from the inventory database for installation by the application installer module.

Other aspects and advantages of the invention will become apparent from the following drawings, detailed description, and claims, all of which illustrate the principles of the invention, by way of example only.

The present invention accordingly comprises the several steps and the relation of one or more of such steps with respect to each of the others, and embodies features of construction, combinations of elements, and arrangement of parts adapted to effect such steps, all as exemplified in the detailed disclosure hereinafter set forth, and the scope of the invention will be indicated in the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically shows a rule-based recommendation system in accordance with various embodiments of the invention;

FIG. 2 schematically shows another recommendation system in which different components of the system are located at different computers in accordance with various embodiments of the invention;

FIG. 3 schematically shows a system that recommends software products based on a computed likelihood that a user will install the recommended software in accordance with various embodiments of the invention;

FIG. 4 depicts examples of user inputs that may be submitted to a web browser application installed on a computing device, and illustrates relevant software application information stored in a software application inventory database in accordance with an embodiment of the invention;

FIG. 5 depicts an example of a browser window having a tab displaying a software application recommendation in accordance with an embodiment of the invention; and

FIG. 6 is a flowchart showing an exemplary process implemented by a software application recommendation system in accordance with an embodiment of the invention.

### DETAILED DESCRIPTION

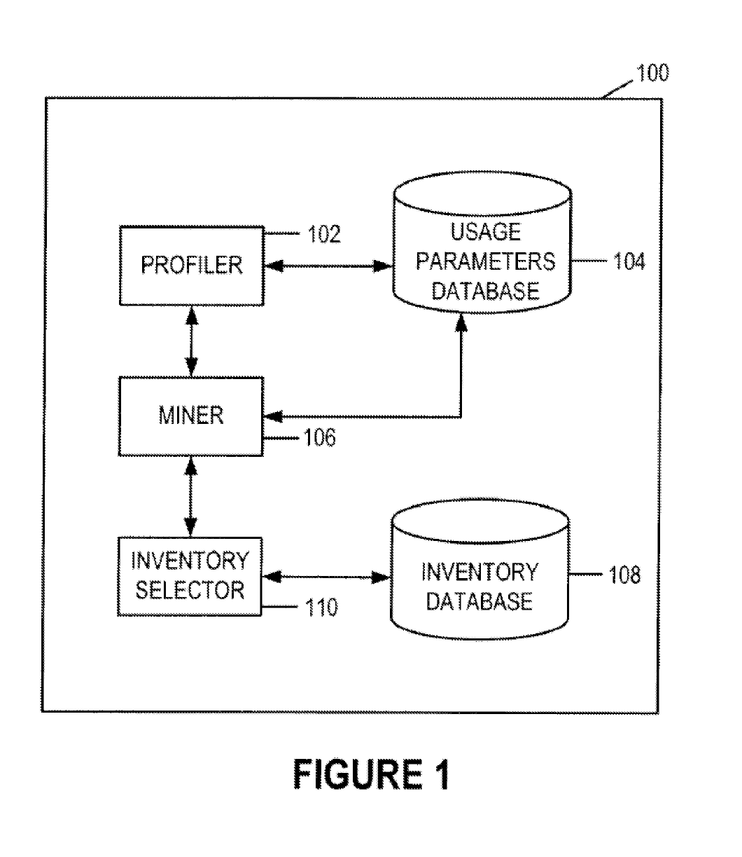

Referring to FIG. 1, an exemplary system 100 for recommending a software application to a user includes a profiler module 102. The profiler module 102 typically collects system (i.e., hardware) parameters associated with the user's computer system such as the type and speed of the processor, disk-access time, size and/or speed of the memory installed, etc. The profiler module 102 also identifies one or more installed operating systems, and the software applications installed on the computer system. The installed software applications may include communication applications such as email, internet phone, and web-browser applications, household applications, and business software. In one instance for example, the profiler module 102 may detect that an email software, a document-preparation software suite, a photo and movie-editing software, and accounting software are installed on the user's computer.

In addition, the profiler module 102 collects various application-execution parameters (e.g., speed of loading, execution, etc.), and application parameters, i.e., parameters associated with the use of the installed applications by a certain user. The application parameters may include, for example, the frequency at which a particular user invokes a certain application, the functions used within the application (e.g., revisioning, charting, etc.). For example, one user of the computer system described above may use the email application and the web browser daily, but may not use the accounting software. Another user, on the other hand, may use the accounting software on a weekly basis and may frequently use the web browser, but may not use the email application.

The application usage parameters corresponding to a user may also include the average duration of use of an application during a day, the distribution of file types stored on the computer (e.g., numbers and percentages of different types of files), sizes of the files, and their association with the installed applications. In some embodiments, the usage parameters include processes that typically run when a particular user logs on, and the resources (e.g., memory consumed, processor time, etc.) used by each of those processes, attributes of the installed applications (e.g., the product's version, latest software patch installed, the digital signature of the vendor making the software, etc.), the errors logs generated by the operating system, and the network communication attributes and data (e.g., average speed of data reception and/or transmission, average size of data exchanged, etc.).

The profiler module 102 may collect the usage parameters including the system and application parameters periodically (e.g., every day, once a week, etc.), when requested by a user, or when a new software application is installed, etc. The user may also specify the frequency at which these parameters are collected. The collected parameters are stored in a local database module 104 at the user's computer.

The miner module 106 analyzes the usage parameters stored in the database 104. In some embodiments, the miner module 106 may receive the usage parameters directly from the profiler module 102, i.e., the parameters may be analyzed (also called mined) prior to storage, or may not be stored at all. During the analysis, the miner module 106 applies rules to the collected parameters. A rule typically relates to the usage parameters, and requires comparing an observed usage parameter (e.g., a parameter collected by the profiler 102) with a nominal value corresponding to that parameter. The rules and/or the nominal parameter values applied by the rules may be embedded in the miner module 106, and/or may be stored in the database 104 and/or another database.

The miner module 106 determines, based on the comparisons described above, which rules were applied successfully and, accordingly, identifies a functionality that may be lacking on the user's computer. The miner 106 then determines a category of software applications that can perform the lacking functionality. As used herein, “category” generally means a class or type of software products that are capable of performing the lacking functionality.

The recommendation system 100 also includes a software application inventory database 108 and an inventory module 110 that receives the recommended category from the miner module 106. From the scenarios described below, PC tune-up software, backup software, and indexing software are some examples of software-application categories. In each category, there may be numerous commercially available products capable of performing a functionality corresponding to that category. These products may be provided by the same vendor (e.g., as a regular version or as a premium version), or by different vendors. The inventory module 110 searches for a software product belonging to the category identified by the miner module 106 in the inventory database 108. If more than one product is found in the inventory database 108, they all may be recommended to the user. The recommendations may include reviews from other users, technical specifications, price, etc.

Alternatively, the inventory module 110 may recommend a product based on various characteristics of the products. Typical characteristics analyzed by the inventory module 110 include price of the product, ratings provided by other users, and whether the user has already purchased a product provided from the vendor that also has a product in the desired category. For example, if the user uses tax-preparation software from one vendor, he may prefer personal-finance software from the same vendor because the two products may be able to readily exchange data with each other.

The following scenarios illustrate the operations of the profiler module 102, the miner module 106, and the inventory module 110. In one instance, the profiler module 102 collects information about the available memory on the computer, the access time to files on the disk, and the average time taken by a browser to load. The collected parameters indicate that the computer has less than 255 Mbytes of available memory, the access time to files on the disk is greater than 10 msec., and the average time taken by the browser to load is greater than 3 seconds.

The miner module 106 analyzes these results by applying various rules. In particular, the miner module 106 identifies that the available memory is less than 512 Mbytes, the disk-access time is greater than 1 msec., and that data-access time is greater than 0.2 seconds. Having determined that the usage parameters differ substantially from the corresponding nominal values (described above) the miner module 106 may recommend a PC tune-up application along with a message that the user's computer can operate significantly faster by tuning the resources of the computer. The inventory module 110 also receives the recommendation from the miner module 106 and searches its inventory for a PC tune-up application. The inventory module 110 then recommends a PC tune-up application available in its inventory.

In a second scenario, the information collected by the profiler module 102 includes the types of the installed applications and the distribution of file types stored on the computer. One of the parameters collected by the profiler module 102 is the number of files of a particular type, indicating, for example, that the computer has more than 5,000 image files stored in the “My Pictures” folder. Based on the collected parameters, the miner module 106 identifies that one of the installed applications relates to digital camera management. The miner 106 also determines that a backup application is not installed on the computer. Based on a set of rules included in the miner module 106, it recommends a backup application, along with a message that family pictures might be lost if not backed up. Moreover, the inventory module 110 identifies and recommends a backup application available in its inventory.

In a third scenario, the parameters collected by the profiler 102 include the types of installed software applications and the distribution of file types stored on the computer. The collected parameters indicate that Microsoft Outlook is installed on the computer, and that the size of the Outlook database is about 20 Gbytes. Using these parameters the miner module 106 determines that one of the installed applications is email software, and that the size of the database used by the email software is greater than 100 Mbytes. Based on the rules provided to the miner module 106, it determines that the speed of email search can be increased using indexing. Accordingly, it recommends an email search and indexing application, with a message that productivity may increase if emails in the Inbox are easily searchable.

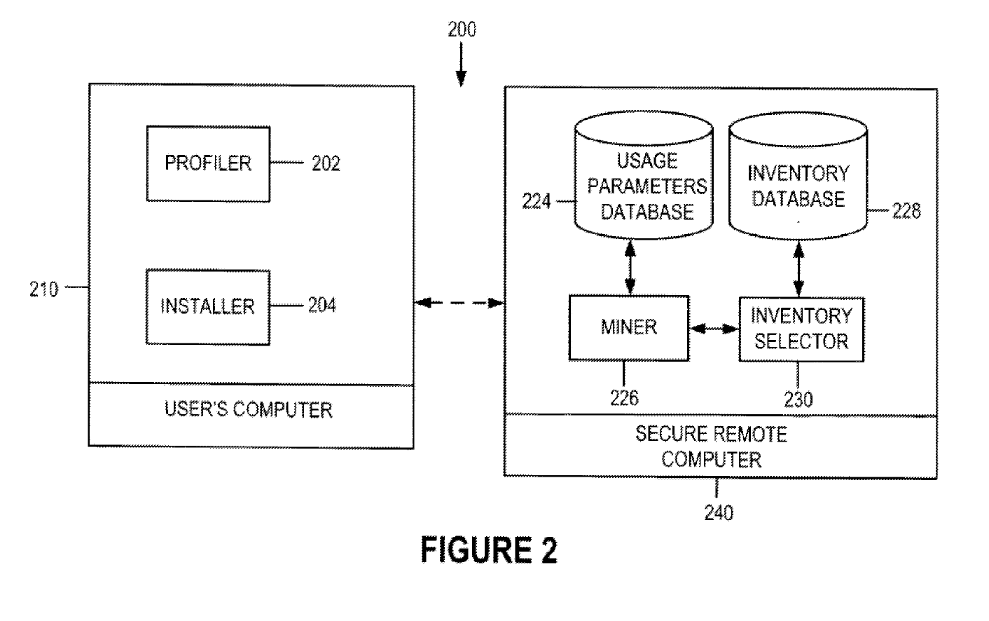

The recommendation system 200 illustrated with reference to FIG. 2 is similar to the system 100 shown in FIG. 1. In the system 200, the profiler module 202 is located at the computer 210 from which the usage parameters are collected. The database module 224, the miner module 226, the inventory database 228, and the inventory module 230, however, are located at a remote computer 240. In the system 200, the profiler module 202 transmits the collected usage parameters to the remote computer 240. The remote computer 240 and the communication between the computers 210, 240 can be secured.

The miner module 226 analyzes the usage parameters to identify a software category, and the inventory module 230 selects a software product belonging to that category, as described above with reference to FIG. 1. Alternatively, or additionally, the miner module 226 may statistically analyze the usage parameters to identify a functionality lacking on the computer 210, and may determine a category of software applications that can provide that functionality. For example, based on a trend in the average number of hard-disk errors, disk-repair software may be recommended, or after detecting a high rate of data exchange, a video acceleration or network bandwidth throttling software may be recommended to speed up the delivery and rendering of multimedia content. The selected product is communicated to the computer 210, and recommended to the user as a message. If the user chooses to test or purchase the recommended product, the installer 204 installs and executes the recommended product. It should be understood, however, that the installer 204 is optional, and that systems that merely recommend a product are within the scope of the invention.

In some embodiments, an inventory database and an inventory module may not be provided. In these implementations, the miner module displays a message to the user recommending the category of the potentially beneficial software. In some embodiments, the miner module, the database, the inventory module, and the inventory database are located individually, or in groups at different computers.

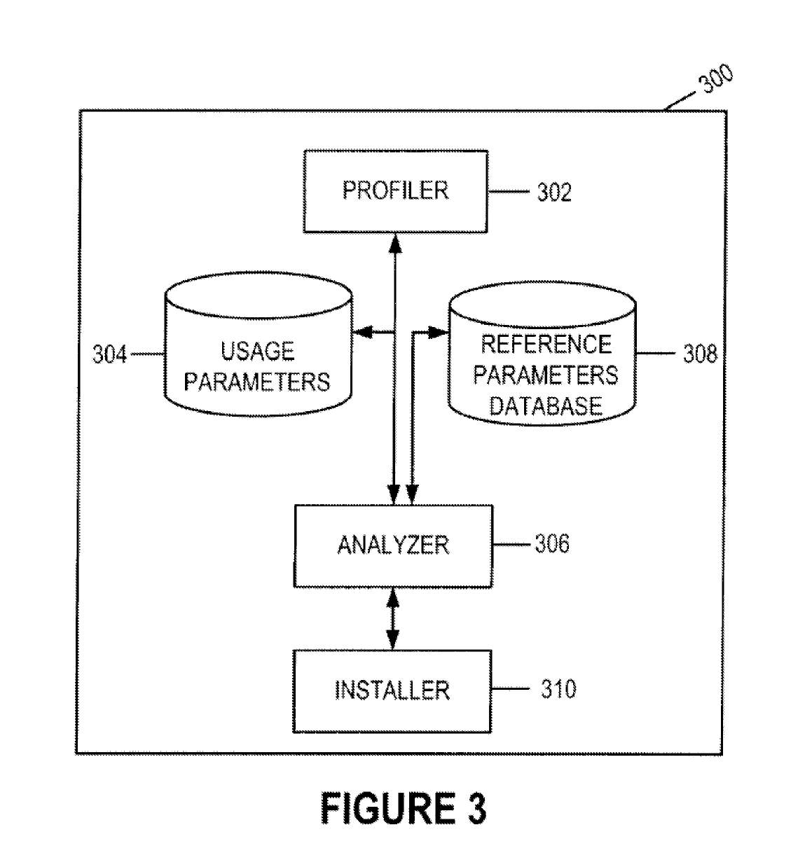

With reference to FIG. 3 and system 300, the profiler module 302 collects the parameters related to the usage of various software applications by a target user, similarly as described above with reference to FIG. 1. The collected usage parameters are stored in the database 304. The analyzer module 306 receives reference parameters that are stored in a reference database 308 and the usage parameters from the database 304, and recommends a software product to the target user. The reference database 308 is optional, and in some embodiments the reference parameters are also stored in the database 304, while in other embodiments the reference parameters are not stored. In general, the reference parameters are also usage parameters, similar to those collected by the profiler module 302, but collected from a different computer system. Alternatively, or additionally, the reference parameters may be collected from the same computer on which the profiler 302 operates, but are related to the usage of software applications by one or more other users of that computer. The parameters collected from different computers and/or users may be aggregated.

A data clustering engine included in the analyzer module 306 forms clusters of software applications corresponding to both the reference and collected usage parameters. As such, the data clustering engine may perform affinity analyses to identify “clusters” representing co-occurrence relationships among the software applications. For example, users who extensively use a spreadsheet software product for significant data analysis may also use a statistical-analysis software. With respect to those users, the spreadsheet and statistical-analysis software products may belong to one cluster, while for other occasional users of the same spreadsheet software, that software and some other software (e.g., presentation software, inventory-management software, etc.) may belong to one cluster.

If a cluster based on the target user's usage parameter is similar to that based on the reference parameters, but lacks a particular product, the analyzer module 306 may determine that because other users having similar usage patterns to the target user have the product lacking in the target user's cluster, the target user would likely benefit from that software product. Furthermore, based on the co-occurrence analysis, the analyzer 306 can also identify “anchor” software products, i.e., products with which a number of other supporting products are generally installed. An email application (e.g., Outlook) is an example of an anchor software, and mail indexing and search products, that are typically included with email applications, are the corresponding supporting products. Financial applications typically require security software to be installed as supporting software to protect financial data. Database applications can also be anchor applications requiring the use of backup software. If a cluster based on the target user's usage parameters lacks one of the supporting products, it is likely that the user may benefit from that product.

After clustering, the analyzer 306 determines a likelihood that the target user will buy the product not currently present in the user's cluster based on parameters such as frequency of use, duration of use, the number of products in a cluster, etc. If the likelihood is determined to be high (e.g., greater than 35%, 60%, 75%, etc.), the analyzer 306 recommends the product that is not currently present in the target user's cluster. If the user chooses to test or purchase the recommended product, the installer 310 installs and executes the recommended product. It should be understood, however, that the installer 310 is optional, and that systems that merely recommend a product are within the scope of the invention.

Advantageously, the recommendation based on clustering is derived from the target user's perspective in that it is based on the knowledge of the software products already installed on the target user's computer, and his usage of those products. Therefore, it is highly likely that the user will find the recommendation valuable, and will therefore test and/or purchase the recommended product. Moreover, unlike the vendor-based systems that collect and store the user's data (e.g., purchase history, search terms used, etc.), the system 300 retains the target user's usage data on that user's computer unless the user consents to sharing it, thereby protecting the user's privacy.

In various embodiments, a system and method for recommending software applications based on application usage parameters pertaining to web browser applications installed on computing devices are also provided. The web browser application can be any browser application that provides an address bar or other input fields for receiving user entries (e.g., text and alphanumeric characters). In some embodiments, the browser application can feature tabbed viewing of web pages, where multiple web sites are accessible via individual tabs of the browser application's window. The application usage parameters can include any of the usage parameters described above with respect to FIGS. 1 to 3. The parameters can additionally, or alternatively, include user inputs (e.g., text data, such as search terms, keywords, URLs, etc.) entered or submitted to the web browser application.

The following describes embodiments of recommendation system 100 configured to recommend software applications based on such web browser application usage parameters. It should be appreciated, however, that any of recommendation systems 200 and 300, or any other similar recommendation system can also be employed to perform the requisite functions. Furthermore, the system and method can be implemented entirely on the user's own computer, or partially on the user's computer and partially on a remote trusted server (e.g., operated by a trusted entity).

In at least one embodiment, recommendation system 100 can be partially or fully implemented as one or more background scripts tied to the operation of a web browser application (e.g., such as an extension of the GOOGLE CHROME BROWSER). Alternatively, recommendation system 100 may be a standalone application configured to interact with the browser application. Profiler module 102 of recommendation system 100 can be configured to monitor the usage parameters during usage of the browser application. In some embodiments, profiler module 102 can include one or more event handlers for detecting browser-related activities, including but not limited to user instructions to the browser application to navigate to URLs, and user entries of one or more search terms or keywords to the browser application's URL address bar or to an Internet search web page (e.g., GOOGLE or BING) loaded in the browser application's window.

The monitored usage parameters can be stored in usage parameters database 104, and can be mined or analyzed (e.g., individually or as a group) to identify one or more search terms or keywords useful for recommending software applications to the user. Miner module 106 can retrieve the usage parameters from usage parameters database 104 for analysis, or alternatively, receive the usage parameters directly from profiler module 102 as they are being monitored.

Miner module 106 can be configured to analyze the parameters for recognizable terms. In at least one embodiment, miner module 106 can include logic code that compares the text in the user inputs against data in a reference database (e.g., a dictionary or other reference source) to extract keywords or terms from the inputs. For example, if a user inputs the search term “Prague hotels”, miner module 106 can access and utilize the reference database to parse the user inputs and identify the words “Prague” and “hotels” therein.

Miner module 106 can also interface with inventory database 108 to identify software applications that are relevant to the extracted words or terms. In at least one embodiment, inventory database 108 can be configured as a relational database (e.g., a lookup table) containing words or terms indexed with information regarding corresponding software applications. Miner module 106 can query inventory database 108 with the extracted terms or words to retrieve information regarding matching software applications. In some embodiments, miner module 106 can be configured to interface directly with inventory database 108. In other embodiments, the miner module can communicate with inventory database 108 via a separate module, such as inventory module 110.

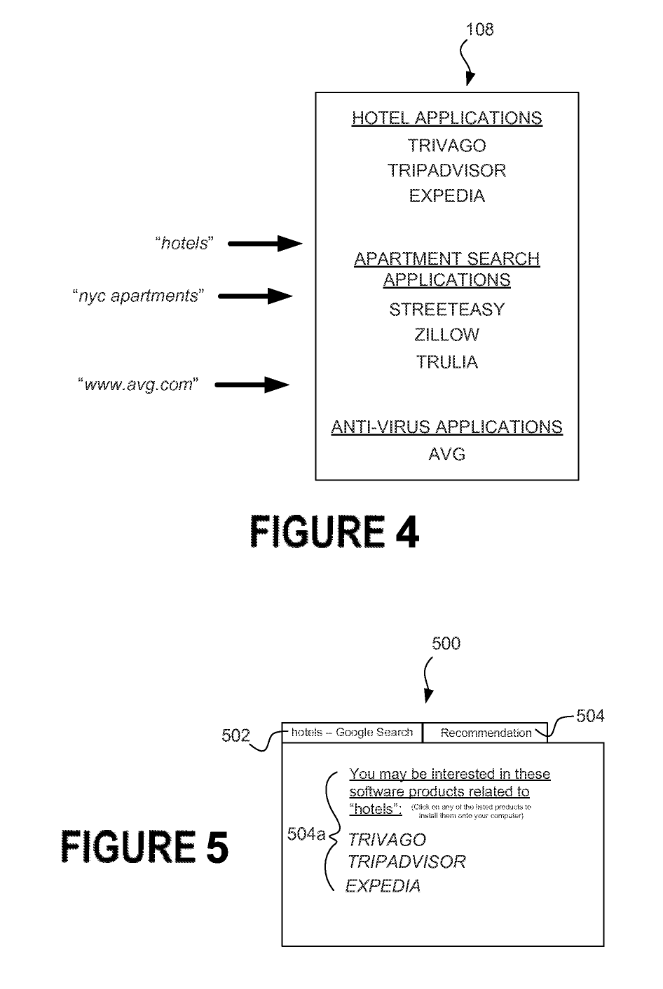

FIG. 4 depicts examples of user inputs that may be submitted to a web browser application installed on a computing device, and illustrates relevant software application information stored in a software application inventory database. As shown in FIG. 4, for example, a user may input any of the keyword “hotels”, the search term “nyc apartments”, and the URL “www.avg.com” into the web browser application. Miner module 106 can identify these terms and words, and can access inventory database 108 to search for relevant software applications. For example, miner module 106 can search inventory database 108 for software applications relating to the keyword “hotels”, identify that information regarding three HOTEL APPLICATIONS (i.e., TRIVAGO, TRIPADVISOR, and EXPEDIA) is stored therein, and retrieve that information. As another example, miner module 106 can search inventory database 108 for software applications relating to the search term “nyc apartments” (or to the terms “nyc” and “apartments” individually), identify that information regarding three APARTMENT SEARCH APPLICATIONS (i.e., STREETEASY, ZILLOW, and TRULIA) is stored therein, and retrieve that information. As yet another example, miner module 106 can search inventory database 108 for software applications relating to the URL “www.avg.com” (or simply the term “avg” extracted from the URL), identify that information regarding one ANTI-VIRUS APPLICATION (i.e., AVG) is stored therein, and retrieve that information.

The reference database and inventory database 108 can each be stored remotely from the computing device or, alternatively, in memory on the computing device. In some embodiments, the reference database and inventory database 108 can be implemented as a common database. In this case, miner module 106 can, for example, access the common database to assist with parsing the user inputs and identifying search terms or words, as well as retrieve information regarding software applications stored in the database that are relevant or match the identified search terms or words.

In at least one embodiment, in addition to analyzing the user inputs in the usage parameters, miner module 106 can also be configured to analyze other application usage data in the usage parameters, such as those described above with respect to FIGS. 1 to 3. Miner module 106 can additionally utilize the application usage data to filter any information regarding software applications (e.g., information retrieved from inventory database 108) that are already installed on the user's computer. For example, a user may input the search term “excel” to the web browser application. If the application usage parameters indicate that a copy of MICROSOFT EXCEL is already installed on the user's computer, and the information regarding relevant software applications includes information on MICROSOFT EXCEL, then miner module 106 can filter MICROSOFT EXCEL from the recommendation, so as to avoid recommending a product that is already present on the user's computer.

In at least one embodiment, the computing device can present the retrieved software application information to the user. Profiler module 102, miner module 106, or one or more other suitable modules can be used to effect the presentation. In some embodiments, the appropriate module can format (or cause to be formatted, e.g., via a graphics processing application of the computing device) the retrieved information, and can direct a display unit of the computing device to display the information. Where the web browser application is configured to support tabbed viewing of web pages, for example, the information can be presented in one of the tabs of the browser application (e.g., the same or a different tab in which the user entered the inputs). FIG. 5 depicts an example of a browser window having a tab displaying a software application recommendation. As shown in FIG. 5, window 500 includes a tab 502 used by a user to search the keyword “hotel” (e.g., via the GOOGLE search engine), and a tab 504 presenting information 504a regarding software applications relevant to that keyword. In some embodiments, rather than displaying information 504a in a new tab of the browser window, recommendation system 100 can cause information 504a to be presented in a new window of the browser application, or via any other appropriate display interface.

In various embodiments, inventory database 108 may also store actual installer files for its software applications. Any computing device equipped with an application installer module (e.g., installer module 204 of recommendation system 200) would thus be able to install the software applications. In this case, the recommendation can include a prompt for user instruction as to whether and which of the retrieved installer files should be executed. For example, as shown in FIG. 5, information 504a can include an instruction prompting a user to select any of the recommended products for installation onto the user's computer. Upon selection of any of the installer files, profiler module 102, miner module 106, or any other appropriate module, can retrieve the selected file from inventory database 108 for installation by the application installer module.

In this way, usage of a web browser application can be monitored to identify relevant software applications that may be beneficial to a user, providing an advantageous software application search and recommendation system unavailable in conventional search engines and web browser applications.

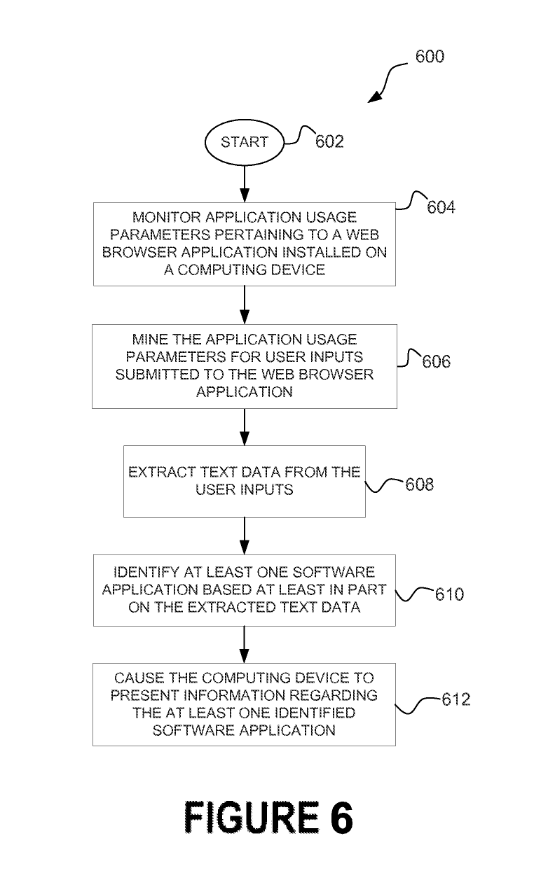

An example of process logic implemented by a recommendation system is illustrated in FIG. 6 as process 600, which begins at step 602. At step 604, application usage parameters pertaining to a web browser application installed on a user's computer, are monitored. For example, profiler 102 of recommendation system 100 can monitor application usage parameters pertaining to a web browser application. At step 606, the application usage parameters can be mined for user inputs submitted to the web browser application. For example, miner module 106 can mine the application usage parameters for user inputs, such as search terms, keywords, and URLs, submitted to the web browser application. At step 608, text data can be extracted from the user inputs. For example, miner module 106 can utilize a reference database (e.g., a dictionary or other similar source) to parse the user inputs and extract text therefrom. At step 610, at least one software application can be identified based on the extract text data. For example, miner module 106 can submit a query to inventory data 108 (e.g., based on the extracted text) to identify at least one relevant software application. At step 612, the user's computer can be controlled to present information regarding the identified software application. For example, recommendation system 100 can cause (e.g., via profiler module 102, miner module 106, or any other appropriate module) the user's computer to display the recommendation (e.g., recommendation 504a of FIG. 5) on a display unit.

It should be understood that the steps shown in process 600 are merely illustrative and that existing steps may be modified or omitted, additional steps may be added, and the order of certain steps may be altered.

Each functional component described above (e.g., the profiler module, the miner module, the databases, the inventory module, the analyzer module, and the installer) may be implemented as stand-alone software components or as a single functional module. In some embodiments the components may set aside portions of a computer's random access memory to provide control logic that affects the interception, scanning and presentation steps described above. In such an embodiment, the program or programs may be written in any one of a number of high-level languages, such as FORTRAN, PASCAL, C, C++, C#, Java, Tcl, PERL, or BASIC. Further, the program can be written in a script, macro, or functionality embedded in commercially available software, such as EXCEL or VISUAL BASIC.

Additionally, the software may be implemented in an assembly language directed to a microprocessor resident on a computer. For example, the software can be implemented in Intel 80×86 assembly language if it is configured to run on an IBM PC or PC clone.

It should also be understood that the foregoing subject matter may be embodied as devices, systems, methods and/or computer program products. Accordingly, some or all of the subject matter may be embodied in hardware and/or in software (including firmware, resident software, micro-code, state machines, gate arrays, etc.). Moreover, the subject matter may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate or transport the program for use by or in connection with the instruction execution system, apparatus, or device.

The computer-usable or computer-readable medium may be for example, an electronic, magnetic, optical, electromagnetic, infrared, or semiconductor system, apparatus, device, or propagation medium. Computer-readable media may comprise computer storage media and communication media.

Computer storage media includes volatile and nonvolatile, removable and non-removable media implemented in any method or technology for storage of information such as computer-readable instructions, data structures, program modules or other data. Computer storage media includes RAM, ROM, EEPROM, flash memory or other memory technology that can be used to store information and that can be accessed by an instruction execution system.

Communication media typically embodies computer-readable instructions, data structures, program modules or other data in a modulated data signal such as a carrier wave or other transport mechanism and includes any information delivery media (wired or wireless). A modulated data signal can be defined as a signal that has one or more of its characteristics set or changed in such a manner as to encode information in the signal.

When the subject matter is embodied in the general context of computer-executable instructions, the embodiment may comprise program modules, executed by one or more systems, computers, or other devices. Generally, program modules include routines, programs, objects, components, data structures and the like, which perform particular tasks or implement particular abstract data types. Typically, the functionality of the program modules may be combined or distributed as desired in various embodiments.

It will thus be seen that the objects set forth above, among those made apparent from the preceding description and the accompanying drawings, are efficiently attained and, since certain changes can be made in carrying out the above methods and in the constructions set forth for the systems without departing from the spirit and scope of the invention, it is intended that all matter contained in the above description and shown in the accompanying drawings shall be interpreted as illustrative and not in a limiting sense. It is also to be understood that the following claims are intended to cover all of the generic and specific features of the invention herein described, and all statements of the scope of the invention, which, as a matter of language, might be said to fall therebetween.

What is claimed is:

1. A method for recommending software applications, involving user interaction with a web browser application installed on a computing device, the method comprising:
monitoring, using at least one processor of the computing device, application usage parameters pertaining to the web browser application installed on the computing device;
mining, using the at least one processor, the application usage parameters for user inputs submitted to the web browser application;
extracting, using the at least one processor, text data from the user inputs;
identifying, using the at least one processor, at least one software application based at least in part on the extracted text data; and
causing, using the at least one processor, the computing device to present information regarding the at least one identified software application.

2. The method of claim 1, wherein monitoring the application usage parameters is effected via at least one event handler installed on the computing device as an extension to the web browser application.

3. The method of claim 1, wherein the user inputs comprise at least one of keywords, search terms, and web site uniform resource locators (“URLs”).

4. The method of claim 1, wherein extracting the text data from the user inputs comprises accessing a reference database containing reference data, and parsing the user inputs based on the reference data.

5. The method of claim 1, wherein identifying the at least one software application comprises accessing a relational database containing content regarding a plurality of software applications.

6. The method of claim 5, wherein the content comprises installer files for the plurality of software applications, and wherein the information regarding the at least one identified software application comprises access to at least one of the installer files.

7. The method of claim 5, wherein the relational database is stored one of in memory on the computing device and remotely from the computing device.

8. The method of claim 1, further comprising mining, using the at least one processor, the application usage parameters for application data regarding software applications presently installed on the computing device.

9. The method of claim 8, wherein identifying the at least one software application is based at least in part on the application data.

10. The method of claim 1, wherein the computing device comprises a display unit, and wherein causing the computing device to present the information comprises causing the computing device to visually present the information on the display unit.

11. The method of claim 1, wherein multiple web sites are accessible via individual tabs of the browser application, and wherein causing the computing device to present the information comprises causing the browser application to display the information in a tab of the browser application.

12. The method of claim 1, wherein the computing device comprises one of a desktop computer, a laptop computer, a notebook computer, a tablet computer, a smartphone, and a personal digital assistant.

13. A system for recommending software applications, involving user interaction with a web browser application installed on a computing device, the system comprising:
a profiler module configured to monitor application usage parameters pertaining to the web browser application installed on the computing device; and
a miner module configured to:
mine the application usage parameters for user inputs submitted to the web browser application;
extract text data from the user inputs;
identify at least one software application based at least in part on the extracted text data; and
cause the computing device to present information regarding the at least one identified software application.

14. The system of claim 13, wherein the profiler module comprises at least one event handler installed on the computing device as an extension to the web browser application.

15. The system of claim 13, wherein the user inputs comprise at least one of keywords, search terms, and web site uniform resource locators (“URLs”).

16. The system of claim 13, wherein the miner module is configured to extract the text data from the user inputs by accessing a reference database containing reference data, and parsing the user inputs based on the reference data.

17. The system of claim 13, wherein the miner module is configured to identify the at least one software application by accessing a relational database containing content regarding a plurality of software applications.

18. The system of claim 17, wherein the content comprises installer files for the plurality of software applications, and wherein the information regarding the at least one identified software application comprises access to at least one of the installer files.

19. The system of claim 17, wherein the relational database is stored one of in memory on the computing device and remotely from the computing device.

20. The system of claim 13, wherein the miner module is further configured to mine the application usage parameters for application data regarding software applications presently installed on the computing device.

21. The system of claim 20, wherein the miner module is further configured to identify the at least one software application based at least in part on the application data.

22. The system of claim 13, wherein the computing device comprises a display unit, and wherein the miner module is configured to cause the computing device to present the information by causing the computing device to visually present the information on the display unit.

23. The system of claim 13, wherein multiple web sites are accessible via individual tabs of the browser application, and wherein the miner module is configured to cause the computing device to present the information by causing the browser application to display the information in a tab of the browser application.

24. The system of claim 13, wherein the computing device comprises one of a desktop computer, a laptop computer, a notebook computer, a tablet computer, a smartphone, and a personal digital assistant.

25. A computer program product comprising a non-transitory medium storing computer executable program logic for recommending software applications, involving user interaction with a web browser application installed on a computing device, the computer executable program logic configured to cause at least one data processor of the computing device to:
monitor application usage parameters pertaining to the web browser application installed on the computing device;
mine the application usage parameters for user inputs submitted to the web browser application;
extract text data from the user inputs;
identify at least one software application based at least in part on the extracted text data; and
cause the computing device to present information regarding the at least one identified software application.
